(19) United States
(12) Patent Application Publication
(10) Pub. No.: US 2018/0294582 A1
(43) Pub. Date: Oct. 11, 2018

(54) Armored Cable Ground Clamp

(71) Applicant: Mike Vernica, Whittier, CA (US)

(72) Inventor: Mike Vernica, Whittier, CA (US)

(21) Appl. No.: 15/479,680

(22) Filed: Apr. 5, 2017

(51) Int. Cl. H01R 4/64; H01R 4/38

(52) U.S. Cl. CPC H01R 4/643; H01R 4/38

(57) ABSTRACT

A ground fitting allows electrical connection between a ground wire carried in a metal sheathing, and a ground point such as a pipe or ground rod. The ground fitting includes an armored cable clamp and a pipe clamp. The pipe clamp is tightened on the pipe or ground rod. The metal sheathing is cut to expose a short length of the ground wire. The ground wire is inserted into a ground wire clamp portion of the armored cable clamp, and the metal sheathing is inserted into an armored cable sheath clamp portion of the armored cable clamp. A ground screw is tightened against the ground wire to hold the ground wire in the ground wire clamp portion and sheath screws tightened closing the sheath clamp on the sheathing are tightened to secure the sheathing in the wire clamp armored cable sheath clamp portion.

### BACKGROUND OF THE INVENTION

The present invention relates to electrical grounding and bonding, and more particularly to a ground fitting for easily grounding or bonding a ground wire carried in spiral metal sheathing (e.g., an armored cable) at an endpoint to a pipe extending a short distance from a wall.

Ground wires frequently require protection from damage. The ground wire is generally a heavy gauge wire, for example eight gauge or six gauge solid, or four gauge stranded, and is generally uninsulated. A common method for protecting a ground wire is to carry the ground wire in a spiral metal sheathing (e.g., armored cable), thereby creating an armored ground wire. Such spiral metal sheathing provides the desired protection to the ground wire.

It is often necessary to connect the ground wire to a ground member (or ground point) exposed to damp conditions. Unfortunately, known grounding clamps may quickly corrode in such conditions, causing both structural and electrical issues

Therefore, a need remains for a ground fitting (or clamp) which resists corrosion.

### BRIEF SUMMARY OF THE INVENTION

The present invention addresses the above and other needs by providing a ground fitting which allows electrical connection between a ground wire carried in a metal sheathing, and a ground point such as a pipe or ground rod. The ground fitting includes an armored cable clamp and a pipe clamp. The pipe clamp is tightened on the pipe or ground rod. The metal sheathing is cut to expose a short length of the ground wire. The ground wire is inserted into a ground wire clamp portion of the armored cable clamp, and the metal sheathing is inserted into an armored cable sheath clamp portion of the armored cable clamp. A ground screw is tightened against the ground wire to hold the ground wire in the ground wire clamp portion and sheath screws tightened closing the sheath clamp on the sheathing are tightened to secure the sheathing in the wire clamp armored cable sheath clamp portion. The armored cable clamp is attached to the pipe clamp selectively angularly aligned to the pipe or ground rod to compete the ground fitting.

In accordance with one aspect of the invention, there is provided an armored cable clamp. The armored cable clamp includes a ground wire clamp and at least one sheath clamp. The ground wire clamp includes a seat and a ground wire screw to press the ground wire into the seat. The sheath clamps include jaws closed by jaw screws and interior ridges for engaging an exterior spiral surface of the armored cable to help retain the armored cable end in the sheath clamps.

In accordance with another aspect of the invention, there is provided a method for connecting an armored ground wire to a pipe or ground rod. The method includes: attaching a pipe clamp to the pipe; cutting a short length of the metal armored cable sheath surrounding a ground wire to expose a short length of the ground wire, laterally inserting the exposed ground wire into a wire clamp while inserting the armored cable sheath into a sheath clamp; tightening a ground screw to grip the ground wire between the ground screw and ground wire seat; tightening jaw screws to close the sheath jaws to grip the armored cable sheath; and attaching the armored cable clamp to the pipe clamp.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is an armored ground wire suitable for use with the present invention.

FIG. 2A is a side view of a ground fitting according to the present invention connecting the armored ground wire to a pipe.

FIG. 2B is a front view of the ground fitting according to the present invention connecting the armored ground wire to the pipe.

FIG. 2C is a top view of the ground fitting according to the present invention connecting the armored ground wire to the pipe.

FIG. 3A is a top view of a pipe clamp top according to the present invention.

FIG. 3B is a front view of the pipe clamp top according to the present invention.

FIG. 3C is a rear view of the pipe clamp top according to the present invention.

FIG. 3D is an end view of the pipe clamp top according to the present invention.

FIG. 4 is a cross-sectional view of the pipe clamp top taken along line 4-4 of FIG. 3A.

FIG. 5A is a bottom view of a pipe clamp bottom according to the present invention.

FIG. 5B is a front view of the pipe clamp bottom according to the present invention.

FIG. 6A is a side view of a armored cable clamp according to the present invention.

FIG. 6B is a front view of the armored cable clamp according to the present invention.

FIG. 6C is a top view of the armored cable clamp according to the present invention.

FIG. 6D is a bottom view of the armored cable clamp according to the present invention.

FIG. 7 shows a side view of an armored cable sheath clamp of the armored cable clamp according to the present invention taken along line 7-7 of FIG. 6D.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

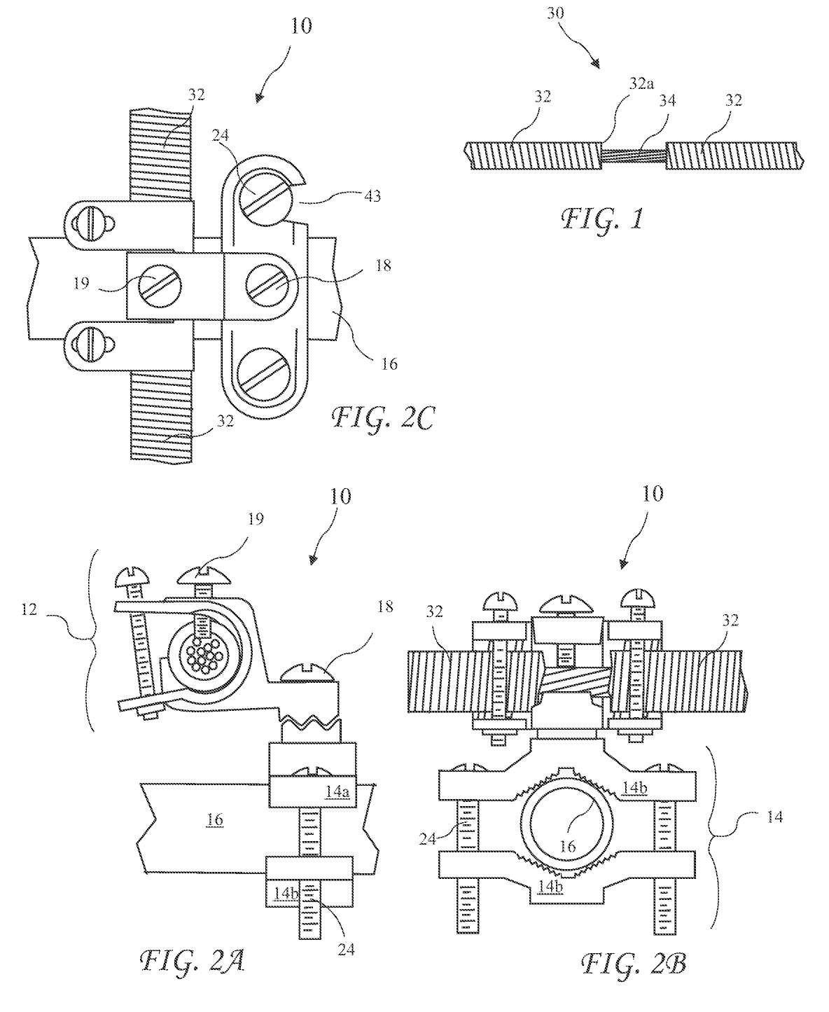

An armored (or sheathed) ground wire 30 suitable for use with the present invention is shown in FIG. 1. The armored ground wire 30 is generally protected by an armored cable sheath 32 formed from a metal spiral allowing flexing while protecting a ground wire 34 inside the armored cable sheath 32. The ground wire 30 is somewhat flexible and allows for some miss-alignment between an armored cable sheath clamp portion 21 and a ground wire clamp portion 46 described hereafter, thus requiring only approximate alignment of features of the armored cable sheath clamp portion 21 and the ground wire clamp portion 46.

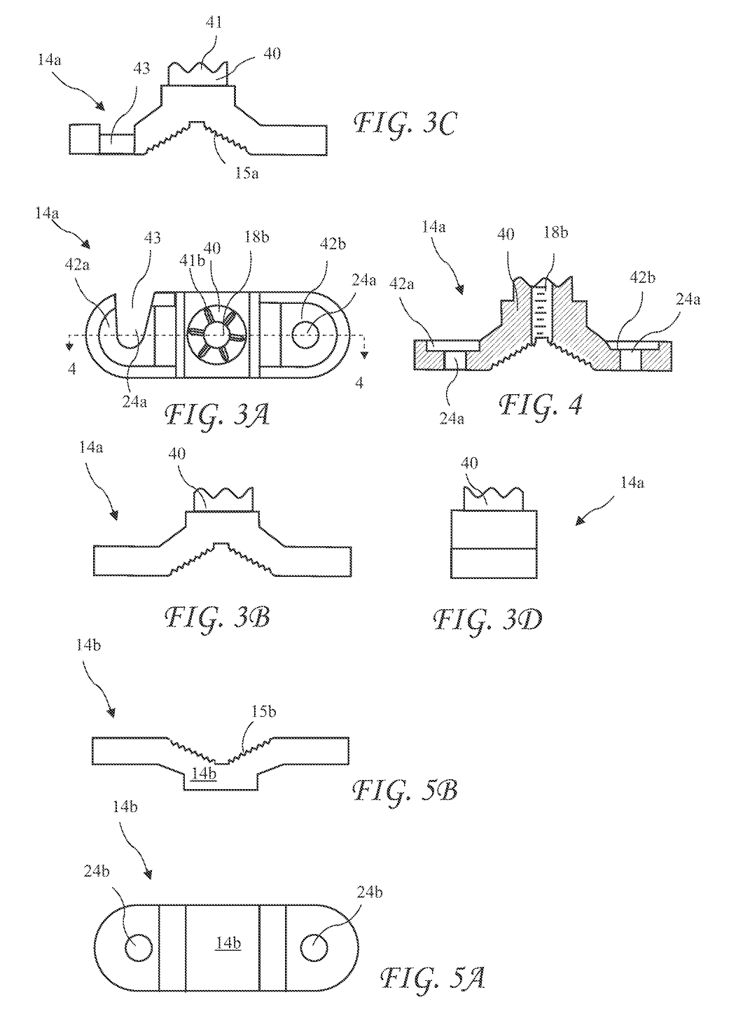

A side view of a ground fitting 10 according to the present invention connecting the armored ground wire 30 to a pipe (or ground rod or any grounded object graspable by the pipe clamp) 16 is shown in FIG. 2A, a front view of the ground fitting 10 connecting the armored ground wire 30 to the pipe 16 is shown in FIG. 2B, and a top view of the ground fitting 10 connecting the armored ground wire 30 to the pipe 16 is shown in FIG. 2C. The ground fitting 10 in comprised of a two piece pipe clamp 14 comprising a top portion 14a and a bottom portion 14b, and an armored cable clamp 12. The pipe clamp 14 is fixed on the pipe 16 by tightening two screws 24. Details of the pipe clamp 14 are disclosed in FIGS. 3A-5B below.

A top view of a pipe clamp top portion 14a according to the present invention is shown in FIG. 3A, a front view of the pipe clamp top portion 14a is shown in FIG. 3B, is a rear view of the pipe clamp top portion 14a is shown in FIG. 3C, an end view of the pipe clamp top portion 14a is shown in FIG. 3D, and a cross-sectional view of the pipe clamp top portion 14a taken along line 4-4 of FIG. 3A is shown in FIG. 4. The pipe clamp top portion 14a includes a pair of downward facing grooved surfaces 15a which are tightened against the pipe 16 to hold the pipe clamp in place. Two vertical screw passages 24a on opposite sides of the pipe clamp top portion 14a provide passage of the screws 24. The screw passages 24a reside in recesses 42a and 42b. A mouth 43 opens one of the recesses 24a allowing the pipe clamp to be positioned on the small pipe 16 without completely removing the screws 24. The raised center 40 of the pipe clamp top portion 14a includes female threaded passage 18b centered on the raised center 40 and teeth 41a for attachment and positioning of the armored cable clamp 12.

A bottom view of a pipe clamp bottom portion 14b is shown in FIG. 5A and a front view of the pipe clamp bottom portion 14b is shown in FIG. 5B. The pipe clamp bottom portion 14b includes threaded holes 24b aligned with the holes 24a to receive the screws 24 to tighten the pipe clamp 14 on the pipe 16. The pipe clamp bottom portion 14b includes a pair of upward facing grooved surfaces 15b which are tightened against the pipe 16 to hold the pipe clamp in place.

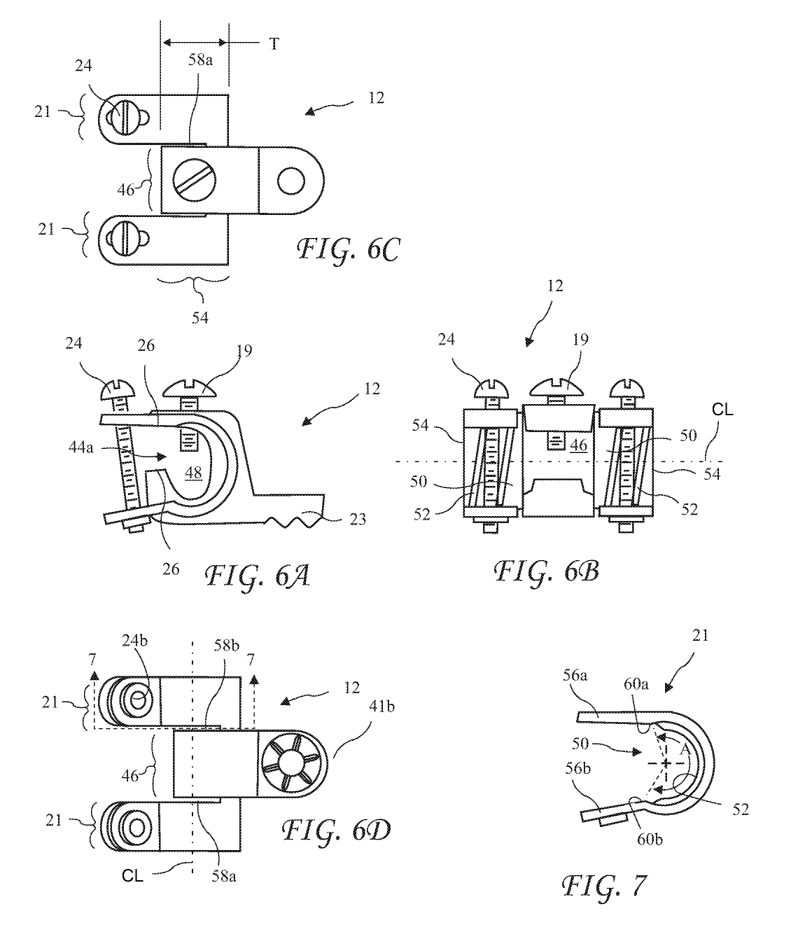

A side view of the armored cable clamp 12 is shown in FIG. 6A, a front view of the armored cable clamp 12 is shown in FIG. 6B, a top view of the armored cable clamp 12 is shown in FIG. 6C, and a bottom view of the armored cable clamp 12 is shown in FIG. 6D. The armored cable clamp 12 includes a downward facing mating seat 23 having teeth 41b configured to mate with teeth 41a of the pipe clamp 14 (see FIG. 3A). The screw 18 passes through the seat 23 and into the threads 18b in the pipe clamp 14 to attach the armored cable clamp 12 to the pipe clamp 14.

The armored cable clamp 12 further includes a ground wire clamp 46 comprising a downward concave ground wire seat 48 and a ground screw 19 advancing downward towards the ground wire seat 48 to push the ground wire 34 against the ground wire seat 48 to make an electrical connection between the ground wire 34 and the armored cable clamp 12. A mouth 44a allows lateral insertion of the ground wire 34 into the ground wire seat 48.

The armored cable clamp 12 further includes at least one armored cable sheath clamp 21 shown in side view in FIG. 7. The armored cable sheath clamps 21 define generally cylindrical “C” shaped throats 50 generally co-axial with the armored cable sheath 32 held in the armored cable sheath clamp 21 (some distortion of the throats 50 or the armored cable sheath 32 preventing an exact co-axial relationship of the throats 50 and the armored cable sheath 32). The generally cylindrical “C” shaped throats 50 have generally circular side openings 54 and forward facing throats 50, and containing raised spiral ridges 52. The throats 50 form partially circular arcs (i.e., extend less than 360 degrees) and extend an angle A of more than 180 degrees, and preferably extend an angle A of between 225 degrees and 300 degrees, are open to the front and further include lips 60a and 60b at ends of the arc and top and bottom fingers 56a and 56b respectively extending forward from the lips 60a and 60b. Screws 24 may be tightened to draw the fingers 56a and 56b together to grasp the armored cable sheath 32 in the armored cable sheath clamps 21 and the ridges 52 engage spiral notches in the armored cable sheath 32. Grooves 58a and 58b largely detach the armored cable sheath clamp 21 from the ground wire clamp 46 facilitating drawing the top and bottom fingers 56a and 56b together to grasp the armored cable sheath 32. The grooves 58a and 58b reaching greater than one half the thickness T of the overlapping portions 54 of the armored cable sheath clamp 21 and the ground wire clamp 46. The throats 50 are sufficiently aligned with the ground wire ground wire clamp 46 to simultaneously clamp the armored cable sheath 32 in the armored cable sheath clamp 21 and clamp the ground wire 34 in the ground wire clamp 46.

The screws 18 and 19 are preferably zinc coated steel, and more preferably have a minimum approximately 0.001 inch thick zinc coating. The screws 24 are preferably stainless steel. The armored cable clamp 12 and the pipe clamp 14 are preferably made of a copper alloy and are more preferably approximately 80 percent copper.

While the invention herein disclosed has been described by means of specific embodiments and applications thereof, numerous modifications and variations could be made thereto by those skilled in the art without departing from the scope of the invention set forth in the claims.

1. A ground fitting comprising:
a pipe clamp comprising:
a pipe clamp top portion having a first mating surface for attachment of an armored cable clamp to the pipe clamp; and
a pipe clamp bottom portion connectable to the pipe clamp top portion to sandwich a grounded object in the pipe clamp for attaching the ground fitting to the grounded object and forming an electrical connection between the ground fitting and the grounded object; and
the armored cable clamp comprising:
a second mating surface for mating to the first mating surface;
at least one armored cable sheath clamp portion configured for grasping an armored cable sheath end inserted into the armored cable clamp, each armored cable sheath clamp portion comprising:
a single piece grasping portion having a centerline (CL) co-axial with the armored cable sheath end held in the armored cable sheath clamp portion;
a partially circular throat of the grasping portion, the throat forming a continuous arc generally co-axial with the centerline (CL) and extending more than 180 degrees about the centerline (CL) and open only to the front of the single piece grasping portion, wherein the armored cable sheath end held in the armored cable sheath clamp resides generally co-axial with the throat and in the throat;
lips extending out from ends of the arc;
a generally circular side opening of the throat perpendicular to the centerline (CL) and configured to receive armored cable sheath into the throat; and
a fastener engaging the lips, the fastener configured to draw the lips together to grasp the armored cable sheath end in the armored cable sheath clamp portion; and
a ground wire clamp portion configured for grasping a ground wire carried in the armored cable sheath.

2. The ground fitting of claim 1, wherein the first mating surface on the pipe clamp top portion and the second mating surface on the armored cable clamp, for attachment of the armored cable clamp to the pipe clamp, permits mounting the armored cable clamp with the ground wire residing at a plurality of angles between zero and 180 degrees to the grounded object the pipe clamp is attached to.

3. The ground fitting of claim 2, wherein the first mating surface and the second mating surface include cooperating features to establish the plurality angles.

4. The ground fitting of claim 3, wherein the first mating surface and the second mating surface include cooperating teeth to establish the plurality angles.

5. The ground fitting of claim 1, wherein the grounded object is a pipe.

6. The ground fitting of claim 1, wherein the grounded object is a ground rod.

7. The ground fitting of claim 1, wherein the throat is sufficiently aligned with the ground wire clamp portion to simultaneously clamp the armored cable sheath in the armored cable sheath clamp portion and clamp the ground wire in the ground wire clamp portion.

8. The ground fitting of claim 1, wherein top and bottom fingers extend forward from the lips and the fastener draws the top and bottom fingers together to close the throat to grasp the armored cable sheath end in the armored cable sheath clamp portion.

9. The ground fitting of claim 6, wherein the throat includes spiral ridges facing the armored cable sheath for engaging spiral notches in the armored cable sheath to secure the armored cable sheath end in the throat.

10. The ground fitting of claim 1, wherein the ground wire clamp portion comprises a ground wire seat and a ground wire screw intersecting the ground wire seat approximately perpendicular to the ground wire seat and approximately laterally centered on the ground wire seat to intersect and thereby clamp the ground wire in the ground wire grasping portion.

11. The ground fitting of claim 1, wherein the at least one armored cable sheath clamp portion comprises two armored cable sheath clamp portions on opposite sides of the ground wire clamp portion.

12. The ground fitting of claim 1, wherein the partially circular throat forms the arc extending between 225 degrees and 300 degrees.

13. The ground fitting of claim 1, wherein:
the armored cable clamp overlaps the ground wire clamp; and
grooves reach though the overlap reaching greater than one half the thickness (T) of the overlap.

14. A ground fitting comprising:
a pipe clamp comprising:
a pipe clamp top portion having a first mating surface for attachment of an armored cable clamp to the pipe clamp; and
a pipe clamp bottom portion connectable to the pipe clamp top portion to sandwich a pipe or ground rod in the pipe clamp, for attaching the ground fitting to the pipe or ground rod, and forming an electrical connection between the ground fitting and the pipe or ground rod; and
the armored cable clamp comprising:
a second mating surface for mating to the first mating surface, the first and second mating surface including cooperating features to attach the armored cable clamp to the pipe clamp at a plurality of angles between zero and 180 degrees;
at least one armored cable sheath clamp portion for grasping the armored cable sheath end inserted into the armored cable clamp, each armored cable sheath clamp portion comprising:
a partially circular throat forming an arc extending more than 180 degrees and open to the front of armored cable clamp, wherein the armored cable sheath end held in the armored cable sheath clamp resides generally co-axial with the throat and in the throat;
lips on forward ends of the arc;
top and bottom fingers extend forward from the lips;
a generally circular side opening of the throat configured to receive the armored cable sheath into the throat; and
a fastener engaging the top and bottom fingers, the fastener configured to draw the lips together to grasp the armored cable sheath end in the armored cable sheath clamp portion; and
a ground wire clamp portion for grasping a ground wire carried in the armored cable sheath, the ground wire clamp comprising;
a ground wire seat reaching laterally through the ground wire clamp; and
a ground wire screw intersecting the ground wire seat and approximately centered on the ground wire seat to intersect and thereby clamp, the ground wire in the ground wire grasping portion,
wherein the throat is sufficiently aligned with the ground wire seat to simultaneously clamp the armored cable sheath in the armored cable sheath clamp and clamp the ground wire in the ground wire clamp.

15. A ground fitting comprising:
a pipe clamp comprising:
a pipe clamp top portion having a first mating surface for attachment of an armored cable clamp to the pipe clamp; and
a pipe clamp bottom portion connectable to the pipe clamp top portion to sandwich pipe or ground rod in the pipe clamp, for attaching the ground fitting to the pipe or ground rod, and forming an electrical connection between the ground fitting and the pipe or ground rod; and
the armored cable clamp comprising:
a second mating surface for mating to the first mating surface, the first and second mating surface including cooperating features to attach the armored cable clamp to the pipe clamp at a plurality of angles between zero and 180 degrees;
two armored cable sheath clamp portions on opposite sides of a ground wire clamp for grasping an armored cable sheath ends inserted into the armored cable clamps, each armored cable sheath clamp portion comprising:
a partially circular throat forming an arc extending more than 180 degrees and open to the front of armored cable clamp, wherein the armored cable sheath end held in the armored cable sheath clamp resides generally co-axial with the throat and in the throat;
lips on forward ends of the arc;
top and bottom fingers extend forward from the lips;
a generally circular side opening of the throat configured to receive the armored cable sheath into the throat; and
a fastener engaging the top and bottom fingers, the fastener configured to draw the lips together to grasp the armored cable sheath end in the armored cable sheath clamp portion; and
a ground wire clamp portion for grasping a ground wire carried in the armored cable sheath, the ground wire clamp comprising;
a ground wire seat reaching laterally through the ground wire clamp; and
a ground wire screw intersecting the ground wire seat and approximately centered on the ground wire seat to intersect and thereby clamp, the ground wire in the ground wire grasping portion; and
grooves reaching though overlaps between the ground wire clamp portion and the armored cable sheath clamp portions, reaching greater than one half the thickness (T) of the overlap,
wherein the throat is sufficiently aligned with the ground wire seat to simultaneously clamp the armored cable sheath in the armored cable sheath clamp and clamp the ground wire in the ground wire clamp.

16. The ground fitting of claim 14, wherein:
the one armored cable sheath clamp portion includes a single piece grasping portion configured for grasping the armored cable sheath end and having a centerline (CL) co-axial with the armored cable sheath end held in the armored cable sheath clamp portion;
the grasping portion includes the partially circular throat and the throat forms a continuous arc generally co-axial with the centerline (CL) and open only to the front of the single piece grasping portion; and
the lips extend out from ends of the arc.

17. The ground fitting of claim 15, wherein:
the armored cable sheath clamp portions include a single piece grasping portion configured for grasping the armored cable sheath ends and having a centerline (CL) co-axial with the armored cable sheath end held in the armored cable sheath clamp portion;
the grasping portions includes the partially circular throats and the throats forms a continuous arc generally co-axial with the centerline (CL) and open only to the front of the single piece grasping portions; and
the lips extend out from ends of the arcs.

18. The ground fitting of claim 9, wherein the spiral ridges are continuous and extend more than 180 degrees.

19. The ground fitting of claim 18, wherein the spiral ridges comprise two side by side spiral ridges in each throat.
